(19) United States
(12) Patent Application Publication
(10) Pub. No.: US 2024/0417220 A1
(43) Pub. Date: Dec. 19, 2024

(54) ELEVATOR CONSTRUCTION ARRANGEMENT AND A METHOD

(71) Applicant: Kone Corporation, Helsinki (FI)

(72) Inventors: Mika IJÄS, Helsinki (FI); Matti RÄSÄNEN, Helsinki (FI); Mikko KUKKOLA, Helsinki (FI); Markku HAAPANIEMI, Helsinki (FI); Janne LAINE, Helsinki (FI); Otto LANZ, Helsinki (FI)

(73) Assignee: Kone Corporation, Helsinki (FI)

(21) Appl. No.: 18/817,026

(22) Filed: Aug. 27, 2024

Related U.S. Application Data
(63) Continuation of application No. PCT/EP2022/054951, filed on Feb. 28, 2022.

(51) Int. Cl. B66B 19/00; B66B 9/00; B66B 11/00; B66B 19/02; E04G 3/28; E04G 3/32

(52) U.S. Cl. CPC B66B 19/002; B66B 9/00; B66B 11/004; B66B 11/0045; B66B 19/005; B66B 19/02; E04G 3/32; E04G 2003/286

(57) ABSTRACT

An elevator construction arrangement comprises: a first hoistway in a building, a first elevator car, a first counterweight, car guide rails for guiding the first car, and counterweight guide rails for guiding the first counterweight, a first elevator hoisting machine and a first suspension roping arranged to suspend the first elevator car and the first counterweight during construction time use, a protection deck mounted within the first hoistway during a first elevator installation in a bottom section of the first hoistway, a hoist device for hoisting a working platform, the hoist device preferably comprises a man riding hoist attachable to the first car or to an installation platform, and a hoist rope attachable to the first car or the installation platform and movable with the hoist device, and a first hoisting point configured to support the working platform via the hoist device and the hoist rope. During a first elevator installation in the bottom section of the first hoistway the first hoisting point is configured to be mounted to the protection deck and the working platform guided on the car guide rails is configured to be used as an installation platform in the bottom section of the first hoistway, and after the first elevator installation, the first car is in construction time use configured to be moved in the bottom section of the first hoistway by the first elevator hoisting machine which is installed at a top of the bottom section of the first hoistway and supported by the car guide rail, the first elevator hoisting machine suspending the first car and the first counterweight together with the first suspension roping, while the first hoisting point and the hoist device are removed from the first hoistway. A method for installing an elevator during construction of a building.

### CROSS-REFERENCE TO RELATED APPLICATION

This application is a continuation of PCT International Application No. PCT/EP2022/054951 which has an International filing date of Feb. 28, 2022, the entire contents of which are incorporated herein by reference.

### FIELD OF THE INVENTION

The invention relates to an elevator construction arrangement and a method for installing an elevator during construction of a building.

### BACKGROUND OF THE INVENTION

The construction of an elevator may especially in high-rise buildings be done in parts along the height of the hoistway. The guide rails and the landing doors may first be installed to a first height in the hoistway, then to a second height etc. A construction time elevator may then be operated on the already installed lower portion of the hoistway while the construction of the elevator is going on in a higher portion of the hoistway.

An installation platform may be used for the construction of the elevator above the construction time elevator operating in the lower portion of the hoistway.

With a traditional elevator installation method, the installation can start only when the roof is closed.

### SUMMARY OF THE INVENTION

An object of the present invention is to present an improved elevator construction arrangement and an improved method for installing an elevator during construction of a building.

It is brought forward a new elevator construction arrangement comprising
a first hoistway in a building, a first elevator car, a first counterweight, car guide rails for guiding the first car, and counterweight guide rails for guiding the first counterweight,
a first elevator hoisting machine and a first suspension roping arranged to suspend the first elevator car and the first counterweight during construction time use,
a protection deck mounted within the first hoistway during a first elevator installation in a bottom section of the first hoistway,
a hoist device for hoisting a working platform, the hoist device preferably comprises a man riding hoist attachable to the first car or to an installation platform, and a hoist rope attachable to the first car or the installation platform and movable with the hoist device,
a first hoisting point configured to support the working platform via the hoist device and the hoist rope; and
during a first elevator installation in the bottom section of the first hoistway the first hoisting point is configured to be mounted to the protection deck and the working platform guided on the car guide rails is configured to be used as an installation platform in the bottom section of the first hoistway, and
after the first elevator installation, the first car is in construction time use configured to be moved in the bottom section of the first hoistway by the first elevator hoisting machine which is installed at a top of the bottom section of the first hoistway and supported by the car guide rail, the first elevator hoisting machine suspending the first car and the first counterweight together with the first suspension roping, while the first hoisting point and the hoist device are removed from the first hoistway.

In a preferred embodiment, the arrangement comprises:
a second hoistway in a building,
a second elevator car, a second counterweight, car guide rails for guiding the second car, and counterweight guide rails for guiding the second counterweight,
a second elevator hoisting machine and a second suspension roping arranged to suspend the second elevator car and the second counterweight during construction time use,
a second hoisting point configured to support the second car via the hoist device and the hoist rope; and
the hoist device is configured to hoist the second car, preferably the man riding hoist and the hoist rope being attachable to the second car and movable with the hoist device, and
during construction time use of the first car a second elevator installation in the second hoistway is carried out and the second elevator with the second car is taken into construction time use along the full height of the building.

In a preferred embodiment, during the second elevator installation and construction time use of the first car the second hoisting point is configured to be mounted to a ceiling of the second hoistway, and the second car, movable with the hoist device attached to the second car and the hoist rope attached to the second car and guided on the car guide rails, is configured to be used as the installation platform in the second hoistway, and
after the second elevator installation, the second car is configured to be moved for construction time use along the full height of the building by the second elevator hoisting machine suspending the second car and the second counterweight together with the second suspension roping, while the second hoisting point and the hoist device are removed from the second hoistway.

In a preferred embodiment, during construction time use of the second car the first hoisting point is configured to be moved to the ceiling of the first hoistway and, after the first elevator is taken out of construction time use and the protection deck is removed from the first hoistway, the first car guided on the car guide rails is configured to be used as the installation platform in the top section of the first hoistway above the bottom section, and
after the top section installation of the first elevator, the first car is configured to be moved for construction time use along the full height of the building by an elevator hoisting machine suspending the first car and the first counterweight together with its first suspension roping, while the first hoisting point and the hoist device are removed from the first hoistway.

In a preferred embodiment, the protection deck comprises a material hoist configured to hoist construction material below the protection deck.

In a preferred embodiment, the material hoist is configured to hoist car guide rails and counterweight guide rails and other heavy elevator components.

In a preferred embodiment, the first car and/or the second car and/or the installation platform is configured to hoist guide rails and other heavy elevator components.

In a preferred embodiment, the arrangement comprises a first overspeed governor to be suspended by the protection deck during the first elevator bottom section installation and during the first elevator top section installation by a structure of the building such as the ceiling or a machine room.

In a preferred embodiment, guide rails are configured to be installed through the protection deck, particularly through a cover comprised by the protection deck.

In a preferred embodiment, the first elevator installation in the bottom section of the first hoistway is started when the building has reached about half of the final height, preferably the protection deck is mounted within the first hoistway approximately at the half height of the final height of the building.

In a preferred embodiment, the first elevator installation in the top section of the first hoistway is started after the building is in full height and/or after completing the installation of the second elevator.

In a preferred embodiment, the first elevator installation in the top section of the first hoistway is started after a ceiling of the first hoistway is closed.

In a preferred embodiment, in case of a machine-room-less elevator, the first elevator hoisting machine installed at a top of the first hoistway is supported by a car guide rail, and rope suspenders for fixing ends of the first suspension roping are supported by the guide rails.

In a preferred embodiment, in case of a machine-room-less elevator, the second elevator hoisting machine to be installed at a top of the second hoistway is supported by a car guide rail, and rope suspenders for fixing ends of the second suspension roping are supported by the guide rails.

In a preferred embodiment, in case of a machine room elevator the elevator hoisting machine used for moving the first elevator car or the second elevator car along full height of the elevator travel and rope suspenders for fixing an end of the suspension roping are installed in a machine room.

In a preferred embodiment, the hoisting point comprises a connecting member equipped with an eye/opening or a corresponding means of attachment for a hook or a corresponding gripping member supporting a diverting pulley to rotatably guide and support the hoist rope.

In a preferred embodiment, in case of the machine-room-less elevator, after the elevator top section installation the overspeed governor is moved from the ceiling to the car guide rail opposite the car guide rail supporting the elevator hoisting machine.

In a preferred embodiment, the elevator hoisting machine is a construction time elevator hoisting machine or a final elevator hoisting machine to be finally installed in the top section of the hoistway or a machine room.

In a preferred embodiment, the working platform comprises the car or at least parts of the car to be guided on the car guide rails.

In a preferred embodiment, the working platform comprises the installation platform.

It is also brought forward a new method for installing an elevator during construction of a building comprising:
providing a first elevator car, a first counterweight, car guide rails for guiding the first car, and counterweight guide rails for guiding the first counterweight,
providing a first elevator hoisting machine and a first suspension roping for suspending the first elevator car and the first counterweight during elevator construction time use,
mounting a protection deck within a first hoistway in the building for a bottom section installation of the first hoistway,
providing a hoist device, the hoist device preferably comprises a man riding hoist attachable to the car or to an installation platform, and a hoist rope attachable to the car or to the installation platform and movable with the hoist device,
guiding the working platform on car guide rails and the first counterweight on counterweight guide rails installed at the bottom of the first hoistway,
attaching to the working platform the hoist device and a hoist rope, providing a first hoisting point to support the working platform via the hoist device and the hoist rope,
wherein the method comprises
during a first elevator installation in the bottom section of the first hoistway mounting the first hoisting point to the protection deck, and installing elevator components in the bottom section using the working platform as an installation platform,
installing a first elevator hoisting machine, supported by the car guide rail at a top of the bottom section of the first hoistway, and installing the first suspension roping to suspend the first car and the first counterweight, and moving the first car in construction time use in the bottom section of the first hoistway while the first hoisting point and the hoist device (6) are removed from the first hoistway.

In a preferred embodiment, the method comprises
providing a second elevator car, a second counterweight, car guide rails to guide the second car, and counterweight guide rails to guide the second counterweight,
providing a second elevator hoisting machine and a second suspension roping to suspend the second elevator car and the second counterweight during elevator construction time use in a second hoistway in the building,
providing a second hoisting point to support the second car via the hoist device and the hoist rope, and
during construction time use of the first car installing a second elevator in the second hoistway and taking the second elevator with the second car into construction time use along the full height of the building.

In a preferred embodiment, the method comprises
during the second elevator installation and construction time use of the first car mounting the second hoisting point to a ceiling of the second hoistway, guiding the second car on car guide rails and the second counterweight on counterweight guide rails installed at the bottom of the second hoistway, attaching to the second car the hoist device and the hoist rope, installing elevator components in the second hoistway using the second car as the installation platform, and
after the second elevator installation, moving the second car in construction time use along the full height of the building by the second elevator hoisting machine suspending the second car and the second counterweight together with the second suspension roping, while the second hoisting point and the hoist device are removed from the second hoistway.

In a preferred embodiment, the method comprises
during construction time use of the second car moving the first hoisting point to the ceiling of the first hoistway and, after the first elevator is taken out of construction time use and the protection deck is removed from the first hoistway, using the first car guided on the car guide rails as the installation platform in the top section of the first hoistway above the bottom section, and
after the top section installation of the first elevator, moving the first car in construction time use along the full height of the building by an elevator hoisting machine suspending the first car and the first counterweight together with the first suspension roping, while the first hoisting point and the hoist device are removed from the first hoistway.

In a preferred embodiment, taking the first elevator out of construction time use comprises removing the suspension ropes, the first hoisting machine and a temporary headroom electrification from the first hoistway.

In a preferred embodiment, the method comprises hoisting construction material below the protection deck by a material hoist comprised by the protection deck.

In a preferred embodiment, the method comprises hoisting car guide rails and counterweight guide rails and other heavy elevator components by the material hoist.

In a preferred embodiment, the method comprises hoisting guide rails and other heavy elevator components by the first car and/or by the second car and/or by the installation platform.

In a preferred embodiment, the method comprises suspending a first overspeed governor by the protection deck during the first elevator bottom section installation and during the first elevator top section installation by a structure of the building such as the ceiling or a machine room.

In a preferred embodiment, the method comprises installing guide rails through the protection deck, particularly through a cover comprised by the protection deck.

In a preferred embodiment, the method comprises starting the first elevator installation in the bottom section of the first hoistway when the building has reached about half of the final height, preferably mounting the protection deck within the first hoistway approximately at the half height of the final height of the building.

In a preferred embodiment, the method comprises starting the first elevator installation in the top section of the first hoistway after the building is in full height and/or after completing the installation of the second elevator.

In a preferred embodiment, the method comprises starting the first elevator installation in the top section of the first hoistway when a ceiling of the first hoistway is closed.

In a preferred embodiment, the method comprises supporting, in case of a machine-room-less elevator, the elevator hoisting machine at top of the first hoistway and/or at top of the second hoistway by the car guide rail and rope suspenders for fixing ends of the suspension roping by the guide rails.

In a preferred embodiment, the method comprises, in case of a machine room elevator used for moving the first elevator car or the second elevator car along full height of the elevator travel, installing the elevator hoisting machine and rope suspenders for fixing an end of the suspension roping in a machine room.

In a preferred embodiment, the method comprises moving the overspeed governor, in case of a machine-room-less elevator, from the ceiling to the car guide rail opposite the car guide rail supporting the elevator hoisting machine.

In a preferred embodiment, the method comprises using the car or at least parts of the car as the working platform to be guided on the car guide rails.

In a preferred embodiment, the method comprises using the installation platform as the working platform.

The method and the arrangement described are preferred for midrise buildings up to 20 floors with a group of two elevators. In such a sectional or staged installation method and arrangement, the elevator is installed in stages for construction time use CTU. The installation can start when the building has reached an agreed height of about ½ of the final height of the building. Then, a CTU elevator can be installed in the bottom section and simultaneously the raising of the building can continue above the operating CTU elevator.

The described method and arrangement enable the elevator installation when the building is raising up, already before a hoistway ceiling is closed and corresponding lifting or hoisting points for elevator installation are in place in the ceiling.

About ½ of the first elevator installation can be already completed at the point when the roof or ceiling above the hoistway is closed. The first elevator in the bottom section can already serve during construction as a construction time elevator while the building is still under construction.

When the building has reached said height of about ½ of the total height of the building, the protection deck can be installed which provides lifting or hoisting points for a man riding hoist and an overspeed governor.

The use of protection decks also protects the installers inside the hoistway. The use of the protection deck also provides an installation base at the bottom area of the top section.

During the construction of the building, site logistics can be improved for the transport of people and goods and based on better site logistics shorter construction time can be achieved. This means that finalized elevators can be handed over to the customer earlier.

Once the roof is closed the installation of the second elevator can start. After completing the installation of the second elevator, it can start to serve as a construction time use elevator for the full height of the building. The first elevator can be taken out of use and the installation of the first elevator can be completed. At least one elevator is ready for construction time use.

### BRIEF DESCRIPTION OF THE DRAWINGS

The invention will in the following be described in greater detail by means of preferred embodiments with reference to the attached drawings, in which:

FIG. 1 shows an arrangement for installing an elevator during construction of a building using a working platform such as a first elevator car as an installation platform,

FIG. 2 shows schematically a side view of a protection deck supporting the working platform such as the elevator car and mounted in a first hoistway in the building,

FIG. 3 shows an installation of a diverting pulley for supporting a hoist device, using a hoisting point on the protection deck,

FIG. 4 shows the arrangement for installing the elevator when the working platform such as the first elevator car is used as an installation platform for about the half height of the building,

FIG. 5 shows a machine-room-less elevator in construction time use in the first hoistway for about the half height of the building,

FIG. 6 shows installing of counterweight fillers in a counterweight frame,

FIGS. 7 and 8 show installation of a second elevator for full height of travel when the building has reached the full height, and the first elevator is in construction time use,

FIG. 9 shows installation of the first elevator for its second half of travel, and the second elevator is in construction time use,

FIG. 10 shows both elevators ready for construction time use along the full height of the building,

FIG. 11 shows an installation of an overspeed governor using a first lifting point on the protection deck,

FIG. 12 shows mechanical components of a machine-room-less elevator installed at top of the hoistway,

FIG. 13 shows preferred details of a passage of a suspension roping for the elevator car and a counterweight,

FIG. 14 shows a machine room elevator ready for construction time use along the full height of the building,

FIG. 15 shows a side view of a protection deck installed diagonally within the hoistway, and

FIG. 16 shows an embodiment of a protection deck provided with a material hoist for directly supporting material without a supporting beam for a material hoist rope.

### DETAILED DESCRIPTION

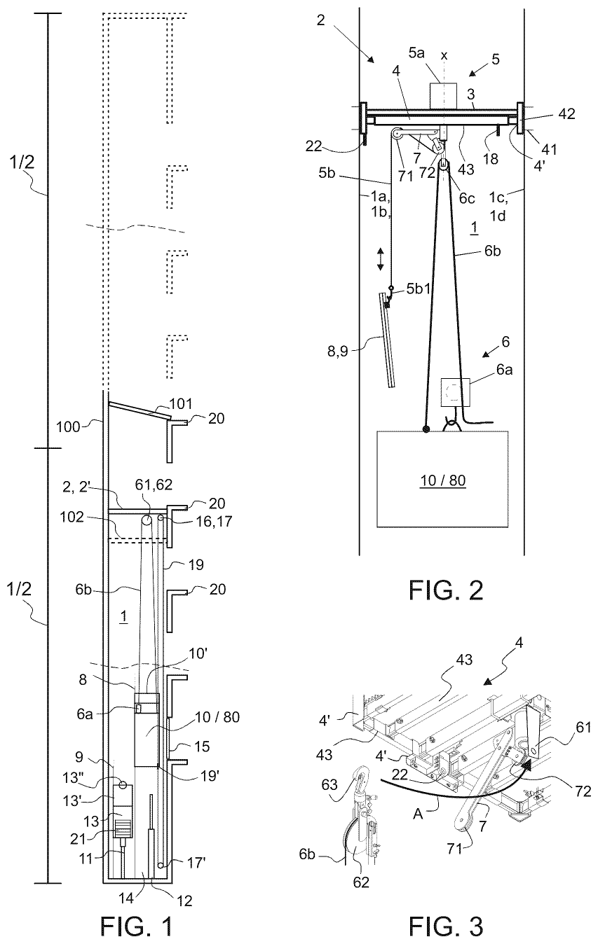

FIG. 1 shows at an initial stage an arrangement for installing a single elevator or a group of elevators during construction of a building 100 when the building has reached about ½ of the final height. Preferably the installation of the elevator starts in a first hoistway 1 when the building core has reached about ½ of the final height.

A weather deck 101 and a temporary working deck 102 may be installed in the first hoistway 1 preferably by the builder. The weather deck 101 may be an inclined waterproof deck which seals the first hoistway 1 to keep it clean and dry.

The elevator installers may install a protection deck 2, 2′ from the working deck 102.

FIGS. 2, 15 and 16 show embodiments of the protection decks 2, 2′ mounted within the first hoistway 1 for protecting the portion of the first hoistway 1 below the protection deck from any possible falling objects.

The protection deck 2′ shown in FIG. 15 differs from the horizontally aligned protection deck 2 in that it can be installed diagonally within the hoistway. Thus, the protection deck 2′ may be used as a top protection deck which can provide at least some of the functions of the weather deck 101. The protection deck 2′ shown in FIG. 15 may be mounted inclined within the hoistway for protecting the portion of the hoistway below the protection deck 2′ from falling objects and fluids during installation. The protection deck 2′ can redirect or deflect falling material to minimize the impact of the falling object. The protection deck 2′ comprises engagement members 4.1 and 4.2 to be engaged with opposite sides of the hoistway. In mounted state of the protection deck 2′ in the hoistway 1 the first engagement member 4.1 may rest on a sill of a landing 20 and the second engagement member 4.2 may engage with the opposite wall.

The protection deck 2, 2′ comprises a frame 4 mounted on walls 1a-1d of the first hoistway 1. The protection deck 2, 2′ comprises a cover 3 co-operating with the frame and extending substantially horizontally across the first hoistway 1. The cover 3 is adapted to protect the hoistway 1 from falling objects and/or water from falling into the hoistway below it. The frame 4 is, without dismantling it, configured to be increased and/or decreased in size, individually in at least one direction in relation to the corresponding adjacent wall 1a, 1b, 1c, 1d of the hoistway. The frame 4 is constructed of preferably telescopic beams 43 fixed to the wall with dedicated wall fixings which can locate on every wall, but the corners are preferred to reduce amount of anchor bolts 41. Preferably the anchor bolts 41 extend into holes of the wall of the hoistway 1, which hoistway wall preferably comprises concrete. A preferred installation of the frame 4 comprises: drilling anchoring interfaces 42 (wall fixing members) to hoistway corners and/or walls; installing frame fixing elements 4′ comprised by the frame 4 to the anchoring interfaces 42.

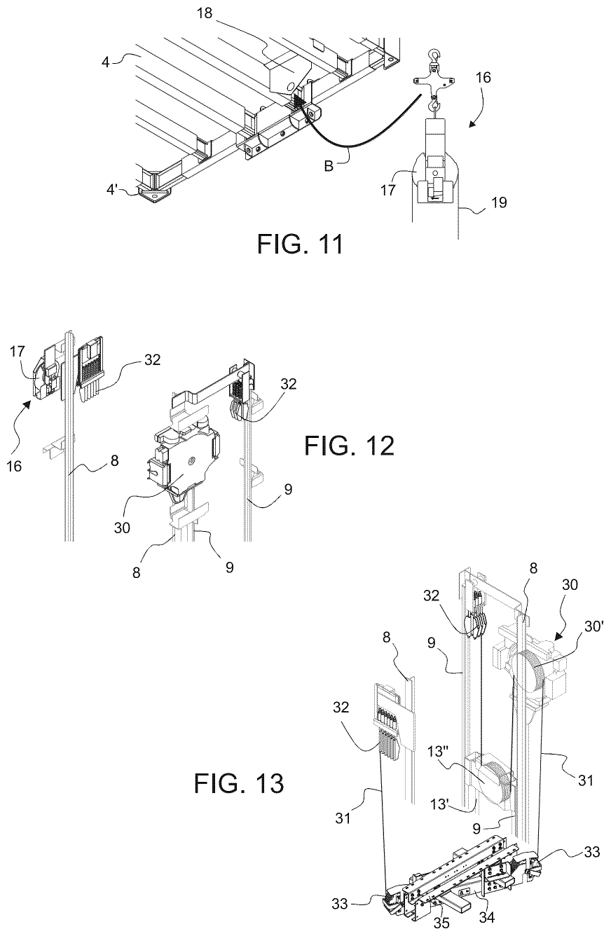

The protection deck 2, 2′ may comprise a first lifting point 18 (see also FIG. 11) supported by the frame 4. The first lifting point 18 may be used for hanging an overspeed governor 16. The first lifting point 18 may comprise a first attaching member supported by the frame 4 for example equipped with an eye/opening or a corresponding similar means of attachment for a hook or a corresponding gripping member for hanging the overspeed governor 16.

The protection deck 2, 2′ may comprise a second lifting point 22 (see also FIG. 3) supported by the frame 4. The second lifting point 22 may be used for hanging a chain hoist. The chain hoist may be used for elevator hoisting machine 30 hoisting. The second lifting point 22 may comprise a second attaching member supported by the frame 4 for example equipped with an eye/opening or a corresponding similar means of attachment for a hook or a corresponding gripping member for hanging the chain hoist.

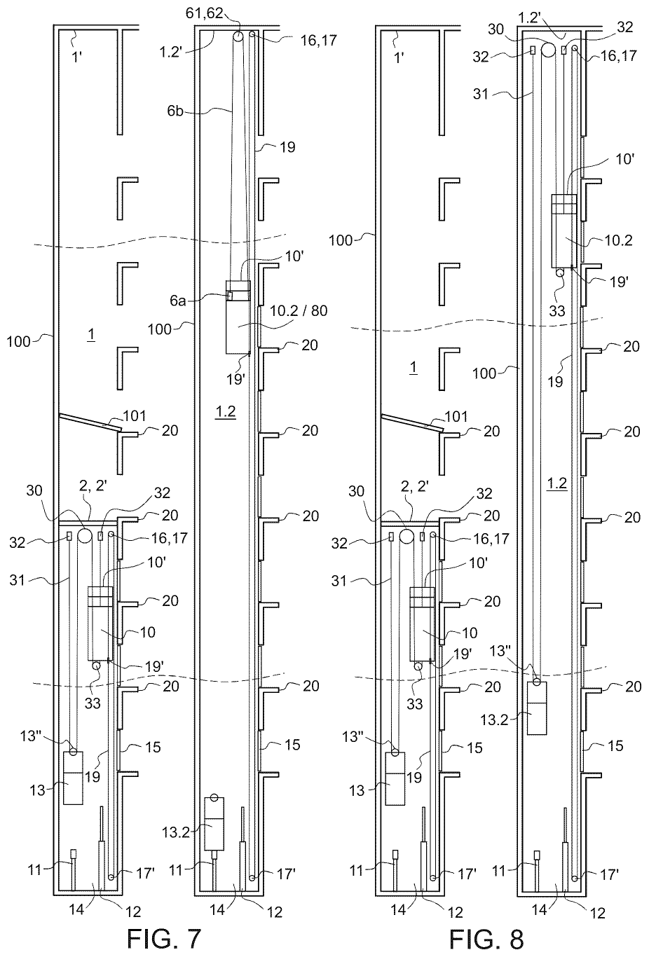

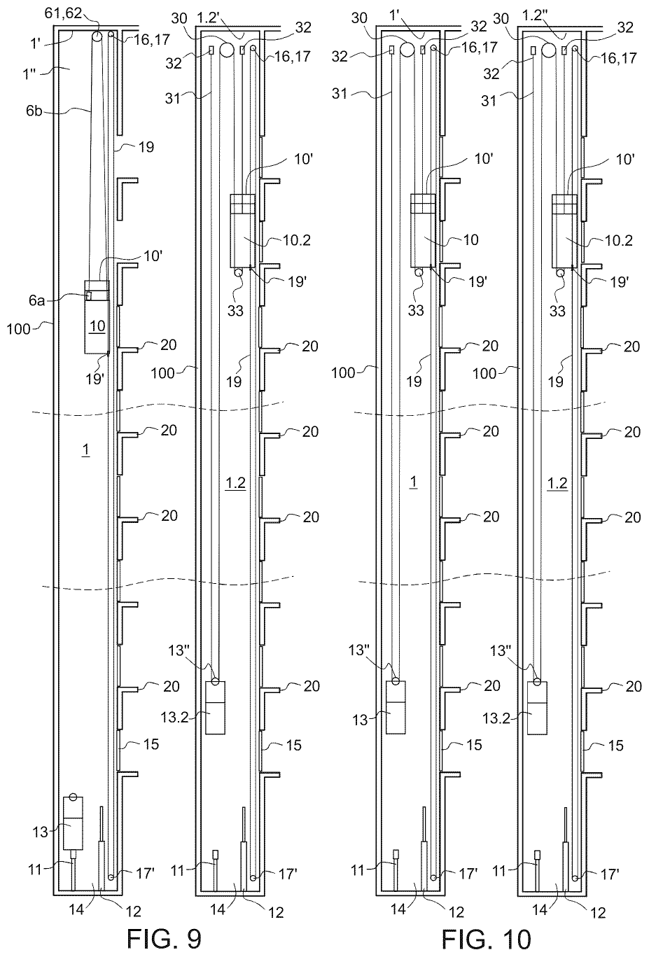

The arrangement comprises a first hoisting apparatus 6 also called a hoist device 6. The first hoisting apparatus 6 serves for hoisting an elevator car 10, 10.2 or an installation platform 80, in FIGS. 1-4 supported by the protection deck 2, 2′, and in FIGS. 7 and 9 supported by a ceiling 1′ of the hoistway 1.

The first hoisting apparatus 6 comprises a first hoisting machine 6a also called a man riding hoist 6a and a first flexible tension member 6b also called a hoist rope 6b movable with the first hoisting machine 6a.

The arrangement comprises a first hoisting point configured to support the first car 10 or the installation platform 80 in the first hoistway, and according to an embodiment a second hoisting point configured to support the second car 10.2 or an installation platform 80 in a second hoistway 1.2 via the first hoisting machine 6a and the first flexible tension member 6b.

In FIG. 2, a first embodiment of a hoisting point formed as a first diverting wheel 6c is rotatably mounted on the protection deck 2 for guiding and supporting the hoist rope 6b.

FIG. 3 shows a preferred second embodiment of the hoisting point comprising a connecting member 61 supported by the frame 4 of the protection deck 2, 2′. A rotatable diverting pulley 62 is supported by a hook 63 or a corresponding gripping member. The hook 63 can be connected to the connecting member 61 as shown by arrow A. The connecting member 61 may be equipped with an eye/opening or a corresponding similar means of attachment for the hook 63 or said corresponding gripping member. Naturally the connection of the diverting pulley 62 and the protection deck may also be formed vice versa, the connecting member may comprise a hook-like gripping member and the attachment means supporting the diverting pulley may respectively comprise an eye or opening. The diverting pulley 62 serves for guiding and supporting the hoist rope 6b.

According to an embodiment the protection deck 2, 2′ comprises a second hoisting apparatus 5 also called a material hoist 5 for hoisting construction material below the protection deck. The material hoist 5 is supported by the protection deck. The material hoist 5 comprises a second hoisting machine 5a also called a material hoisting machine 5a mounted on the protection deck 2, 2′, preferably in particular on the frame 4 thereof, and a second flexible tension member 5b also called a material hoist rope 5b movable with the material hoisting machine 5a. The material hoist rope 5b hangs suspended by the material hoisting machine 5a, and the material hoist rope 5b is provided with a connector 5b1 at a lower end thereof, such as a hook for example, connected or connectable with a construction material 8, 9 to be hoisted. In the arrangement of FIG. 2, the connector 5b1 is connected to a construction material 8, 9 to be hoisted, which construction material 8, 9 is a guide rail section.

According to an embodiment the protection deck 2, 2′ comprises a supporting beam 7 connected pivotally to the frame 4, and a second diverting wheel 71 mounted on said supporting beam 7. The material hoist rope 5b is guided to pass from the material hoisting machine 5a to the second diverting wheel 71, over it and from the second diverting wheel 71 downwards in the hoistway 1. The supporting beam 7 is more specifically connected to the frame 4 preferably pivotally around a vertical axis x as well as around a horizontal axis relative to the frame 4. Preferably the location of the second diverting wheel 71 relative to the frame is adjustable by pivoting the supporting beam 7 around said vertical axis and/or said horizontal axis. The protection deck may comprise a third diverting wheel 72 for guiding the material hoist rope 5b to pass from the material hoisting machine 5a to the second diverting wheel 71.

FIG. 16 shows another embodiment of the protection deck 2 provided with the material hoist 5 for directly supporting material without a supporting beam 7 for the material hoist rope 5b. The material hoist rope 5b may hang directly from the material hoist 5a mounted on a horizontally aligned or an inclined protection deck.

The protection deck 2, 2′ with auxiliary equipment may be used as movable installation tool for hoisting of large loads such as: a movable machine room of an elevator located below the protection deck or, as shown in FIGS. 1, 2 and 4, an elevator car 10 or an installation platform 80 below the protection deck 2, 2′, and construction material 8, 9.

The two embodiments of the hoisting point shown in FIGS. 2 and 3 enable mounting of the first hoisting machine 6a separate from the protection deck 2, 2′. The first hoisting machine 6a may be mounted on the first elevator car 10 and the first flexible tension member 6b passes around the diverting pulley 62 connected to the first hoisting point 61.

The material hoist 5 may be used to hoist car guide rails and counterweight guide rails and other heavy elevator components during the installation of the elevator.

Once the protection deck 2, 2′ is installed and the first hoistway 1 is sealed, the elevator installation can start for the bottom section in the first half of the first hoistway 1 below the protection deck 2, 2′.

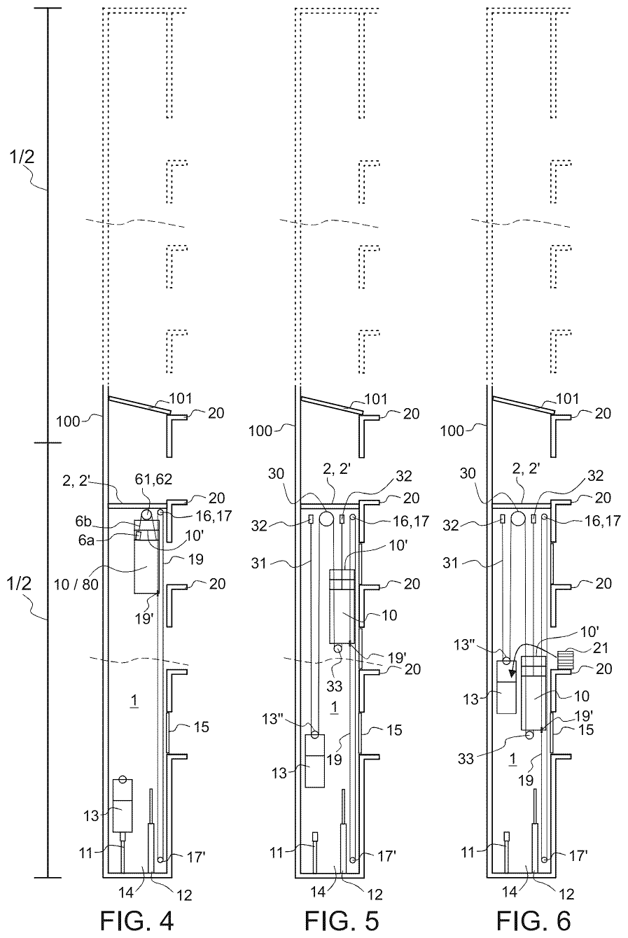

In short, in the bottom section of the first hoistway 1, which may cover about half of the final height of the first hoistway, car guide rails 8, counterweight guide rails 9, a counterweight buffer assembly 11, a car buffer assembly 12, a counterweight (CWT) 13 and a working platform 10, 80 are installed in a pit 14. The working platform 10, 80 is then used as the installation platform (FIG. 4). The working platform is moved with the help of the man riding hoist 6a, utilizing the first hoisting point 6c, 61 of the protection deck 2, 2′. The landing doors 15 and other elevator hoistway components are installed in the first elevator hoistway 1.

According to an embodiment by the car 10 is meant at least parts of the car, such as a car sling, which may be guided on the car guide rails 8. According to an embodiment the working platform comprises the car with the car sling which is complemented by a platform such as a working deck for the installer. According to an embodiment the working platform comprises the car with the sling but does not have walls and a roof. According to an embodiment the car is equipped also with walls and a roof. According to an embodiment the car is a final car. According to an embodiment, the working platform comprises the car 10 or at least parts of the car to be guided on the car guide rails. According to an embodiment, the working platform comprises the installation platform 80.

According to an embodiment, the bottom section may be extended by moving the protection deck 2 upwards in the first hoistway 1, for example some landings 20 upwards, and continuing the bottom section installation using the car 10 supported by the protection deck as the installation platform. According to an embodiment, the bottom section extending installation may be implemented using the installation platform 80 supported by the protection deck as the installation platform.

The first elevator installation below the protection deck 2, 2′ is then completed for construction time use. A first elevator hoisting machine 30 and first elevator suspension ropes 31 are installed and a temporary headroom electrification is finalized in the uppermost part of the first hoistway 1 below the protection deck. Thereafter the first elevator is inspected and handed over for construction time use to serve half of the building height at lower part of the building 100 (FIG. 5).

While the first elevator is installed at the bottom part of the building 100 in the first hoistway 1, the building construction continues normally above it.

In short, according to an embodiment, as soon as the building has reached the full height, the installation starts in a second elevator hoistway 1.2 when a roof 1.2′ of the second hoistway 1.2 is closed. A second elevator is installed along the full length of the second hoistway 1.2. Thereafter the second elevator is inspected and handed over for construction time use to serve full height of the building 100 (FIGS. 7 and 8).

The first elevator may be taken out of use by removing the first suspension ropes 31, the first hoisting machine 30 and the temporary headroom electrification from the first hoistway 1. The weather deck 101 and the protection deck 2 may be removed or according to an embodiment the protection deck 2, 2′ may be moved upwards in the first hoistway for extending the bottom section of the first hoistway. For example, the protection deck may be moved some landings 20 upwards, and the bottom section installation may be continued using the car 10 supported by the protection deck as the installation platform.

As a preparation for an elevator jump to the top section, the man riding hoist 6a hoisting point 61 is moved to the roof 1′ of the first hoistway 1 as shown in FIG. 9. The first hoisting machine 30 is moved to the top of the first hoistway 1 or to a machine room 50 above the first hoistway 1, and new longer first suspension ropes 31 are installed or extended ropes are installed. A final electrification may be installed to a first headroom 1″ or in case of the machine room elevator, to the machine room 50. The first elevator is now ready for construction time use along the full height of the building as shown in FIG. 10. In case the second elevator has been installed, the builder has now two fully functional CTU elevators in use. People and goods transportation may be dedicated for each elevator as wished.

In more detail, starting from the installation of the first elevator in the bottom section of the first hoistway 1, once the protection deck 2, 2′ is properly in place in the first hoistway 1, a first overspeed governor 16 (OSG) and the man riding hoist 6a are installed to the protection deck, preferably working from the working deck 102. The first overspeed governor 16 comprising an OSG upper pulley 17 may be installed to the protection deck 2, 2′ via the first lifting point 18 attached to the protection deck as shown by arrow B in FIG. 11. The chain hoist may be attached via the second lifting point 22 to the protection deck for hoisting of the first elevator hoisting machine 30. An OSG rope 19 may be passed over the OSG upper pulley 17. The man riding hoist 6a with the hoist rope 6b is installed to the first hoisting point 61 in the protection deck (FIG. 3). Preferably the OSG rope 19 ends and the hoist rope 6b ends are temporarily routed to a landing 20 of the building 100.

The material hoist 5 may be installed on top of the protection deck 2, 2′. The working deck 102 may be removed (preferably by the builder) and the OSG rope 19 ends and the hoist rope 6b ends may be lowered to the pit 14. Guide rails 8, 9 may be placed into the pit. Guide rails may be lifted using the material hoist 5.

A first round of guide rails 8, 9 may be installed and aligned in the pit area by suitable plumbing apparatus, preferably guide rail plumbing tools are installed on the protection deck 2. The CWT buffer 11 and the car buffer 12 are installed in the pit 14. An OSG lower pulley 17′ with an OSG tension weight may be installed. The first CWT 13 with a frame 13′ filled partly, preferably 40%, with CWT fillers 21 and equipped with at least one CWT pulley 13″ may be installed to be guided by the CWT guide rails 9.

According to an embodiment the first car 10 is installed inside the first hoistway 1 to be guided by the car guide rails 8. The first car 10 may be equipped with a car sling having a top beam and a bottom beam. The OSG rope 19 may be fixed to the first car by OSG rope terminals 19′ and guided around the upper and lower OSG pulleys. A balustrade 10′ may be installed on the first car. A safety gear may be connected to the car sling and the OSG rope 19. An automatic safety gear trigger (ASGT) may be attached to the car 10. The ASGT engages the safety gear automatically in the event of hoist rope failure or manually when it is necessary to secure the car. The man riding hoist 6a is attached to the first car 10 for moving the first car during installation time.

Moving the first car 10 with the man riding hoist 6a and using the first car 10 as the installation platform, the first car and first counterweight guide rails are installed and aligned up to the first temporary headroom below the protection deck 2 according to plumb lines formed by for example plumb wires attached to the protection deck 2 or using laser tools for plumbing. Preferably the first car 10 is used for lifting guide rails. Guide rails may be lifted using the material hoist 5. Guide rails may be fitted using a guide rail lifting clamp to lift each rail. The guide rails may be installed through the protection deck 2 to allow a later dismantling of the protection deck 2 from the first car 10 roof. Suitable openings for the guide rails may be cut to the protection deck cover 3.

In some cases, a skewed pulley beam 34 shown in FIG. 13 is installed to the car sling bottom beam 35. A skewed pulley beam may also be installed to the car sling top beam.

Using the first car 10 as the installation platform, the landing doors 15 may be installed, preferably from third floor upwards, up to topmost floor of the bottom section, and preferably simultaneously the door-to-door electrification (if any) is installed. The bottom landing door may be installed. An elevator hoistway and pit electrification may be installed below the protection deck 2. Also landing call stations to each floor 20 of the bottom section may be installed.

The first car 10 may be parked to the topmost landing of the bottom section and secured in place as shown in FIG. 4, by activating the safety gear and using a parking chain.

According to an embodiment the bottom section may be extended before taking the car 10 into construction use by moving the protection deck 2, 2′ higher in the hoistway 1, for example some landings 20 upwards, thus presenting a jump from the situation of FIG. 4. Thus, at least one elevator jump above the initial bottom section during installation may be performed before supporting the car 10 from the ceiling 1′ of the hoistway 1. In connection with the jump, the overspeed governor 16, the material hoist 5 and the hoisting point 61 may remain supported by the protection deck 2, 2, and the OSG rope 19 may be extended or replaced. Moving the car 10 with the man riding hoist 6a and using the car 10 as the installation platform, the guide rails and further elevator equipment may be installed in the area below the protection deck in the upper part of the extended bottom section as described above for the initial bottom section.

Preparations are then made to support the first car 10 and the first counterweight 13 by the first suspension ropes 31 suspended by rope suspenders 32 and the first elevator hoisting machine 30 so that the first elevator can serve as construction time elevator for half of the building height at the lower part of the building 100.

Preferably the first elevator hoisting machine 30 is hoisted close to the first hoistway 1 wall before installing the last car guide rail 8 using a chain hoist hanging from the second lifting point 22 supported by the protection deck 2. The chain hoist may be manually operated.

The first elevator hoisting machine 30 is installed to the car guide rail 8 to be supported by the car guide rail 8. The first elevator hoisting machine 30 can be a construction time elevator hoisting machine or a final elevator hoisting machine to be finally installed in the first headroom 1″ in the top section of the first hoistway 1 after the elevator jump.

The rest of the mechanical components is installed below the protection deck as shown in FIG. 12, such as the guide rails 8, 9, and the rope suspenders 32 supported by the guide rails. On each of the rope suspenders 32, an end of a first suspension roping 31 can be fixed.

The first car 10 may be parked to the temporary headroom of the bottom section near the topmost landing of the bottom section and secured in place as shown in FIG. 4, by activating the safety gear and using a parking chain.

Working from the first car 10 roof, the first overspeed governor 16 is moved from the protection deck 2, 2′ to be supported by the car guide rail 8 opposite the car guide rail supporting the first elevator hoisting machine 30 and the OSG rope 19 tightness may be adjusted.

Using the first car 10 as the installation platform, the landing doors 15 may be installed, preferably from third floor upwards, up to topmost floor of the bottom section, and preferably simultaneously the door-to-door electrification (if any) may be installed. The bottom landing door may be installed. An elevator hoistway and pit electrification may be installed below the protection deck 2. Also landing call stations to each floor 20 of the bottom section may be installed. The electrification with associated final components such as sensors and positioning members, signalization components, lightning, a car door with sill and the landing door to the second landing may be installed.

The traveling cable may be installed to the first hoistway 1 wall for example using the material hoist 5 and respectively to the first car 10 and connected to the electrification.

The first suspension roping 31 is arranged to suspend the first car 10 and the first counterweight 13 for bottom section of the elevator. The first suspension ropes 31 are preferably wound on cable drums (not shown in Figures) from bottom section of the elevator so that suitable length of the first suspension ropes 31 may be unwound from each cable drum during the installation of the construction elevator. The weight of the first elevator hoisting machine 30, as well as the load exerted by the first suspension roping 31 passing around a drive wheel of the first elevator hoisting machine 30, is carried by the guide rail section 8, 9, and transmittable by the guide rail section to the guide rail sections below it at least partly so that the complete weight of the of the first elevator hoisting machine 30, as well as the load exerted by the first suspension roping 31 passing around said drive wheel. The load exerted by the first suspension roping 31 passing around said drive wheel is formed partially by weight of the first suspension roping 31 and partially by the elevator units, such as the first car 10 and the first counterweight 13 suspended by the first suspension roping 31. The suspension roping passage shown in FIG. 13 may be used for the first roping 31 installed for the first elevator in the first half of the building height at the lower part of the building 100.

FIG. 13 shows preferred details of a passage of a suspension roping for the elevator car and a counterweight in case of the machine-room-less elevator when the elevator hoisting machine is supported by the car guide rail.

The suspension ropes 31 pass from the first rope suspender 32 downwards to a first car pulley 33 and further horizontally to a second car pulley 33. The car pulleys 33 may be positioned at the outer ends of the skewed pulley beam 34 extending across the sling bottom beam 35 of the car 10, 10.2. The skewed pulley beam 34 may extend in the horizontal direction. The car may thus be supported on the skewed pulley beam 34 and thereby on the suspension ropes 31 passing over the car pulleys 33. The suspension ropes 31 pass after the second car pulley 33 upwards to a drive wheel 30′ of the elevator hoisting machine 30 and further downwards to the CWT pulley 13″. The suspension ropes 31 pass after the CWT pulley 13″ finally upwards to the second rope suspender 32. The counterweight 13 is hanging from the counterweight pulley 13″.

Temporary compensation chains may be installed in the bottom section of the elevator.

The man riding hoist 6a is detached from the first car 10 and taken out of the first hoistway. The automatic safety gear trigger (ASGT) may be detached from the car. The material hoist 5 with the material hoist rope 5b may be removed from the protection deck 2 and used on top of the next section, when the building has reached that height.

For a preferred CWT filler 21 installing, the car may be positioned about to the middle of the bottom section. Working from the car roof, the rest of the CWT fillers 21 may be installed in the CWT frame 13′ as shown in FIG. 6.

After final mechanics and electronics installation and safety inspection, the first elevator in the bottom section of the first hoistway 1 is ready for commissioning for the construction time use.

FIGS. 7 and 8 show an example installation of the second elevator for full height of travel after the building 100 has reached the full height and the first elevator is in construction time use for about the half height of the building. According to an embodiment the installation will be continued in the second elevator hoistway 1.2 after the roof 1.2′ of the second elevator hoistway 1.2 is closed.

According to an embodiment the first hoisting machine 6a and the first flexible tension member 6b movable with the first hoisting machine may be attached to the second car 10.2. The second car is supported by a second hoisting point 6c, 61 via the first hoisting machine 6a and the first flexible tension member 6b.

During the second elevator installation the second hoisting point may be mounted to a ceiling 1′ of the second hoistway 1.2 and the second car 10.2 (or according to another embodiment the installation platform 80) guided on the car guide rails 8 may be used as the installation platform in the second hoistway.

After the second elevator installation, the second car is for construction time use along the full height of the building moved by a second elevator hoisting machine suspending the second car and the second counterweight together with its second suspension roping, while the second hoisting point and the first hoisting apparatus may be removed from the second hoistway.

The second elevator is installed along the full length of the second hoistway 1.2. Thereafter the second elevator is inspected and handed over for construction time use to serve full height of the building 100 (FIGS. 7 and 8).

According to an embodiment the bottom section of the first hoistway (and/or according to another embodiment similarly sections of the second hoistway below the top section) may be extended after construction time use of the bottom section, before installing the top section of the hoistway, by moving the protection deck 2, 2′ higher in the first hoistway, for example some landings 20 upwards, the movement starting a jump from the situation of FIG. 5. Thus, at least one elevator jump above the bottom section, the first elevator having been in construction time use, may be performed before supporting the first car 10 from the ceiling 1′ of the first hoistway 1. The first suspension ropes 31 may be removed and reeled onto rope reels. In connection with the jump, the overspeed governor 16, the material hoist 5 and the hoisting point 61 may be supported by the protection deck 2, 2′, and the OSG rope 19 may be extended or replaced. The car 10 may be moved with the man riding hoist 6a and using the car 10 as the installation platform, the guide rails and further elevator equipment may be installed in the area below the protection deck in the upper part of the now extended section. The below section top components such as the first elevator hoisting machine 30, the rope suspenders 32 and the electrification may be moved to a temporary headroom of the now installed section. The first suspension ropes 31 are extended or replaced with longer ones. The elevator is inspected and handed over for construction time use.

FIG. 9 shows installation of the first elevator for its about second half of travel, and the second elevator is in construction time use. As a preparation for an elevator jump so that the first car 10 can serve as the installation platform for the top section of the first hoistway 1 after the first elevator jump, the man riding hoist 6a hoisting point 61 with diverting pulley 62 and hoist rope 6b are installed to hang temporarily from the first hoistway ceiling 1′ for example via an eyebolt bolted to the ceiling.

After all builders' decks, in other words, the weather deck 101 and temporary working decks 102 are removed from the first hoistway 1, the top section plumbing may be performed by installing plumb lines formed by for example plumb wires attached in a plumbing jig to a topmost landing in case of the machine-room-less elevator or using laser tools for plumbing. The plumb lines are aligned according to the guide rails in the bottom section. In case of the machine room elevator a plumbing template may be set on the machine room 50 floor.

During CTU of the second elevator, the first elevator may be taken out of CTU. When extending the travel of the first car, the temporary compensation chains may be removed from the car and the CWT and lowered to the pit 14. The automatic safety gear trigger (ASGT) wire may be attached to the car 10.

The hoist rope 6b may be lowered near the protection deck, and after the protection deck cover 3 is removed, lowered to the car roof.

The first CWT 13 may be fixed in place using preferably installation clamps, the first car 10 positioned as high as possible.

The hoist rope 6b is driven through the man riding hoist 6a and the man riding hoist 6a is attached to the first car 10, preferably to the car sling top beam.

The automatic safety gear trigger (ASGT) may be attached. The first car 10 may be parked to the temporary headroom of the bottom section near the topmost landing of the bottom section and secured in place, by activating the safety gear and using the parking chain.

The suspension ropes 31 may be removed and reeled onto rope reels. Working from the car roof, the protection deck may be removed from the hoistway preferably by dismantling telescopic beams 43 thereof, removing the anchoring interfaces 42 and cutting the anchor bolts 41.

The bottom section first hoistway 1 top components such as the first elevator hoisting machine 30, the rope suspenders 32 and the electrification may be removed.

The first OSG 16 may be installed to hang temporarily from the first hoistway ceiling 1′ for example via an eyebolt bolted to the ceiling in case of a machine-room-less elevator. The OSG rope 19 may be attached to the OSG rope terminals 19′ in the first car 10 and guided around the OSG lower pulley 17′ with tension weight in the pit 14 while adjusting the length of the OSG rope 19.

Using the car 10 as the installation platform, the car and counterweight guide rails are installed and aligned up to the first headroom 1″, and the traveling cable may be moved up. The rest of the mechanical components may be installed in the first headroom 1″, such as the first elevator hoisting machine 30 and the rope suspenders 32 supported by the guide rails, and first hoistway 1 top electrification and other components. Working from the first car 10 roof, the first overspeed governor 16 may be moved from the ceiling 1′ to be supported by the car guide rail 8 opposite the car guide rail supporting the first elevator hoisting machine 30, and the OSG rope 19 tightness may be adjusted. Using the first car 10 as the installation platform, the top section the landing doors 15 are installed. The top section electrification is installed. Also landing call stations to each floor 20 of the bottom section are installed. The electrification with associated final components such as sensors and positioning members, signalization components, and lightning may be installed.

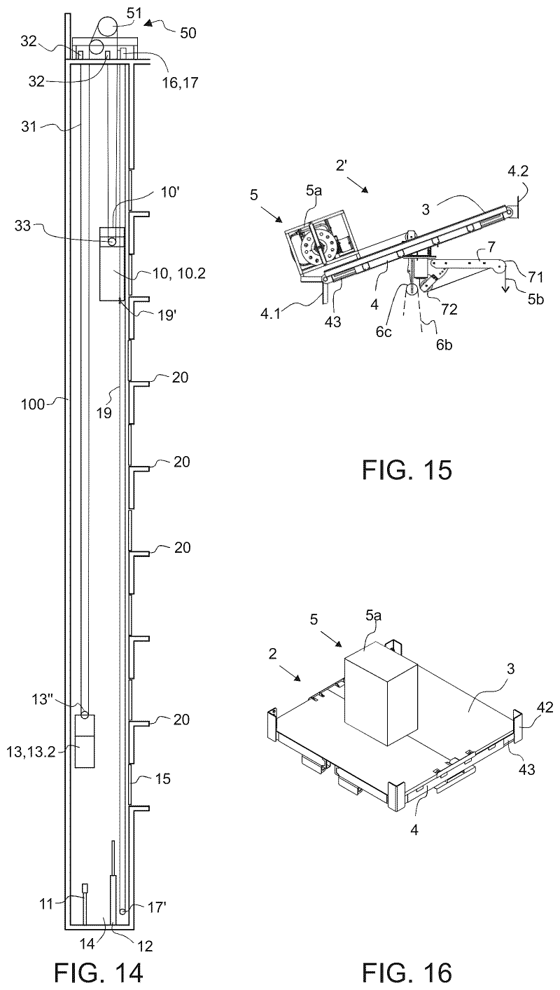

Alternatively, in case of an elevator with a machine room the elevator hoisting machine 51, the rope suspenders 32, the OSG 16 and a controller and machine room electrification are installed in the machine room 50 shown in FIG. 14.

The suspension ropes 31 may be installed as shown for example in FIG. 13. A compensation chain may be installed along the full travel of the elevator. The man riding hoist 6a may be detached from the car 10 and taken out of the first hoistway 1. The automatic safety gear trigger (ASGT) may be detached from the first car 10.

After final mechanics and electronics installation and safety inspection, the first elevator is ready for commissioning for the construction time use the full height of the building.

FIG. 10 shows both elevators ready for construction time use along the full height of the building.

FIG. 14 shows preferred details of a passage of a suspension roping in case of an elevator with a machine room 50. The elevator is ready for construction time use along the full height of the building 100. In case of the machine room elevator the rest of the mechanical components may be installed in the machine room 50 above the first hoistway 1 and/or the second hoistway 1.2, such as the elevator hoisting machine 51 and the rope suspenders 32. On each of the rope suspenders 32, an end of a suspension roping 31 can be fixed. The suspension ropes 31 pass from the first rope suspender 32 downwards to at least one car pulley 33. The at least one car pulley 33 may be positioned on top of the car 10, 10.2 or at the outer ends of a pulley beam 34 which may be skewed extending across the sling bottom beam or across the sling top beam of the car 10, 10.2. The skewed pulley beam may extend in the horizontal direction. The suspension ropes 31 pass after the at least one car pulley 33 upwards to wheels of the elevator hoisting machine 51 and further downwards to the at least one CWT pulley 13″. The suspension ropes 31 pass after the at least one CWT pulley 13″ finally upwards to the second rope suspender 32. The counterweight 13 is hanging from the counterweight pulley 13″.

According to a preferred embodiment, the overspeed governor OSG 16 used during construction time may be replaced with a final OSG.

According to a preferred embodiment, the at least one counterweight pulley 13″ used during construction time may be replaced with a final counterweight pulley.

According to a preferred embodiment, the car pulley beam 34 used during construction time may be replaced with a final car pulley beam.

According to a preferred embodiment, the construction time elevator first and/or second hoisting machine 30, 50 used during construction time may be replaced with a final first and/or second elevator hoisting machine.

According to a preferred embodiment, the construction time signalization used during construction time may be replaced with a final signalization.

It will be obvious to a person skilled in the art that, as the technology advances, the inventive concept can be implemented in various ways. The invention and its embodiments are not limited to the examples described above but may vary within the scope of the claims.

1. An elevator construction arrangement comprises
a first hoistway in a building,
a first elevator car, a first counterweight, car guide rails for guiding the first elevator car, and counterweight guide rails for guiding the first counterweight,
a first elevator hoisting machine and a first suspension roping arranged to suspend the first elevator car and the first counterweight during construction time use,
a protection deck mounted within the first hoistway during a first elevator installation in a bottom section of the first hoistway,
a hoist device configured to hoist a working platform, the hoist device comprises a man riding hoist attachable to the working platform such as to the first elevator car or at least parts of the elevator car or to an installation platform, and a hoist rope attachable to the first car or the installation platform and movable with the hoist device,
a first hoisting point configured to support the working platform via the hoist device and the hoist rope; and
during a first elevator installation in the bottom section of the first hoistway the first hoisting point is supported by the protection deck and the working platform guided on the car guide rails serves as an installation platform in the bottom section of the first hoistway, and
after the first elevator installation, the first elevator car is in construction time use movable in the bottom section of the first hoistway by the first elevator hoisting machine which is at a top of the bottom section of the first hoistway and supported by the car guide rail, the first elevator hoisting machine suspending the first elevator car and the first counterweight together with the first suspension roping, when the first hoisting point and the hoist device have been removed from the first hoistway.

2. The arrangement according to claim 1, comprising
a second hoistway in the building,
a second elevator car, a second counterweight, car guide rails for guiding the second elevator car, and counterweight guide rails for guiding the second counterweight,
a second elevator hoisting machine and a second suspension roping arranged to suspend the second elevator car and the second counterweight during construction time use in the second hoistway,
a second hoisting point configured to support the second elevator car via the hoist device and the hoist rope; and
the hoist device is configured to hoist the second elevator car, the man riding hoist and the hoist rope being attachable to the second elevator car and movable with the hoist device, and
during construction time use of the first elevator car a second elevator installation in the second hoistway is carried out and the second elevator with the second elevator car is taken into construction time use along the full height of the building, and
preferably during the second elevator installation and construction time use of the first elevator car the second hoisting point is supported by a ceiling of the second hoistway, and the second elevator car, movable with the hoist device attached to the second elevator car and the hoist rope attached to the second elevator car and guided on the car guide rails, serves as the installation platform in the second hoistway, and
after the second elevator installation, the second elevator car is movable for construction time use along the full height of the building by the second elevator hoisting machine suspending the second elevator car and the second counterweight together with the second suspension roping, when the second hoisting point and the hoist device have been removed from the second hoistway.

3. The arrangement according to claim 2, wherein during construction time use of the second elevator car the first hoisting point is supported by the ceiling of the first hoistway and, after the first elevator has been taken out of construction time use and the protection deck has been removed from the first hoistway, the first elevator car guided on the car guide rails serves as the installation platform in the top section of the first hoistway above the bottom section, and
after the top section installation of the first elevator, the first elevator car is movable for construction time use along the full height of the building by an elevator hoisting machine suspending the first elevator car and the first counterweight together with its first suspension roping, when the first hoisting point and the hoist device have been removed from the first hoistway.

4. The arrangement according to claim 1, wherein in case of a machine-room-less elevator, the first elevator hoisting machine installed at a top of the first hoistway is supported by a car guide rail, and rope suspenders for fixing ends of the first suspension roping are supported by the guide rails; and
preferably the second elevator hoisting machine to be installed at a top of the second hoistway is supported by a car guide rail, and rope suspenders for fixing ends of the second suspension roping are supported by the guide rails;
and wherein in case of a machine room elevator the elevator hoisting machine used for moving the first elevator car or the second elevator car along full height of the elevator travel and rope suspenders for fixing an end of the suspension roping are installed in a machine room.

5. The arrangement according to claim 1, wherein the hoisting point comprises a connecting member equipped with an eye/opening or a corresponding means of attachment for a hook or a corresponding gripping member supporting a diverting pulley to rotatably guide and support the hoist rope.

6. A method for installing an elevator during construction of a building comprising
providing a first elevator car, a first counterweight, car guide rails for guiding the first elevator car, and counterweight guide rails for guiding the first counterweight,
providing a first elevator hoisting machine and a first suspension roping for suspending the first elevator car and the first counterweight during elevator construction time use,
mounting a protection deck within a first hoistway in the building for a bottom section installation of the first hoistway,
providing a hoist device, the hoist device comprises a man riding hoist attachable to the first elevator car serving as a working platform or at least parts of the first elevator car serving as the working platform or to an installation platform serving as the working platform, and a hoist rope attachable to the first elevator car or to the installation platform and movable with the hoist device,
guiding the working platform on car guide rails and the first counterweight on counterweight guide rails installed at the bottom of the first hoistway,
attaching to the working platform the hoist device and the hoist rope, providing a first hoisting point to support the working platform via the hoist device and the hoist rope,
wherein the method comprises
during a first elevator installation in the bottom section of the first hoistway mounting the first hoisting point to the protection deck, and installing elevator components in the bottom section using the working platform as an installation platform,
installing a first elevator hoisting machine, supported by the car guide rail at a top of the bottom section of the first hoistway, and installing the first suspension roping to suspend the first elevator car and the first counterweight, and moving the first elevator car in construction time use in the bottom section of the first hoistway while the first hoisting point and the hoist device are removed from the first hoistway.

7. The method according to claim 6, comprising
providing a second elevator car, a second counterweight, car guide rails to guide the second elevator car, and counterweight guide rails to guide the second counterweight,
providing a second elevator hoisting machine and a second suspension roping to suspend the second elevator car and the second counterweight during elevator construction time use in a second hoistway in the building,
providing a second hoisting point to support the second elevator car via the hoist device and the hoist rope, and
during construction time use of the first elevator car installing a second elevator in the second hoistway and taking the second elevator with the second elevator car into construction time use along the full height of the building.

8. The method according to claim 7, comprising during the second elevator installation and construction time use of the first elevator car mounting the second hoisting point to a ceiling of the second hoistway, guiding the second elevator car on car guide rails and the second counterweight on counterweight guide rails installed at the bottom of the second hoistway, attaching to the second elevator car the hoist device and the hoist rope, installing elevator components in the second hoistway using the second elevator car as the installation platform, and
after the second elevator installation, moving the second elevator car in construction time use along the full height of the building by the second elevator hoisting machine suspending the second elevator car and the second counterweight together with the second suspension roping, while the second hoisting point and the hoist device are removed from the second hoistway.

9. The method according to claim 7, comprising during construction time use of the second elevator car moving the first hoisting point to the ceiling of the first hoistway and, after the first elevator is taken out of construction time use and the protection deck is removed from the first hoistway, using the first elevator car guided on the car guide rails as the installation platform in the top section of the first hoistway above the bottom section, and
after the top section installation of the first elevator, moving the first elevator car in construction time use along the full height of the building by an elevator hoisting machine suspending the first elevator car and the first counterweight together with the first suspension roping, while the first hoisting point and the hoist device are removed from the first hoistway, wherein
preferably taking the first elevator out of construction time use comprises removing the suspension ropes, the first hoisting machine and a temporary headroom electrification from the first hoistway.

10. The method according to claim 6, comprising hoisting construction material below the protection deck by a material hoist comprised by the protection deck, and
preferably hoisting car guide rails and counterweight guide rails and other heavy elevator components by the material hoist.

11. The method according to claim 6, comprising hoisting guide rails and other heavy elevator components by the first elevator car and/or by the second elevator car and/or by the installation platform.

12. The method according to claim 6, comprising suspending a first overspeed governor by the protection deck during the first elevator bottom section installation and during the first elevator top section installation by a structure of the building such as the ceiling or a machine room, and
preferably moving the overspeed governor, in case of a machine-room-less elevator, from the ceiling to the car guide rail opposite the car guide rail supporting the elevator hoisting machine.

13. The method according to claim 6, comprising installing guide rails through the protection deck, particularly through a cover comprised by the protection deck.

14. The method according to claim 6, comprising starting the first elevator installation in the bottom section of the first hoistway when the building has reached about half of the final height, preferably mounting the protection deck within the first hoistway approximately at the half height of the final height of the building, and/or
starting the first elevator installation in the top section of the first hoistway after the building is in full height and/or after completing the installation of the second elevator, and/or
starting the first elevator installation in the top section of the first hoistway when a ceiling of the first hoistway is closed.

15. The method according to claim 6, comprising, in case of a machine-room-less elevator, supporting the elevator hoisting machine at top of the first hoistway and/or at top of the second hoistway by the car guide rail and rope suspenders for fixing ends of the suspension roping by the guide rails; or
in case of a machine room elevator used for moving the first elevator car or the second elevator car along full height of the elevator travel, installing the elevator hoisting machine and rope suspenders for fixing an end of the suspension roping in a machine room.

16. The method according to claim 6, comprising using the elevator car or at least parts of the elevator car as the working platform to be guided on the car guide rails, or
using the installation platform as the working platform.
